(19) United States
(12) Patent Application Publication
(10) Pub. No.: US 2015/0351542 A1
(43) Pub. Date: Dec. 10, 2015

(54) CABINET SIDEWALL STRUCTURE WITH HIDDEN WALL HOLES

(71) Applicant: Kuang-Yi CHEN, New Taipei City (TW)

(72) Inventor: Kuang-Yi CHEN, New Taipei City (TW)

(21) Appl. No.: 14/731,424

(22) Filed: Jun. 5, 2015

(30) Foreign Application Priority Data
Jun. 6, 2014 (TW) 103119755

(51) Int. Cl. A47B 96/20; B32B 3/26

(52) U.S. Cl. CPC A47B 96/206; B32B 3/266; B32B 2479/00; B32B 2250/02

(57) ABSTRACT

A cabinet sidewall structure with hidden wail holes has a rectangular plate and at least one thin sheet material. The rectangular plate has a first plane, a second planar surface located opposite to the first plane, a first side surface and a second side surface located opposite to the first side surface. The first planar surface and/or the second planar surface are provided with at least two wall hole rows in front and rear areas. Each wall hole row has a plurality of wall holes arranged vertically. The thin sheet material is adhered to the first planar surface and/or the second planar surface and covers the walls holes. The wall holes are covered by the thin sheet material when the wall holes are not used, i.e. when the wall holes are not be interposed by shelf support pegs.

### RELATED APPLICATIONS

This application claims priority to Taiwan Application Serial Number 103119755, filed Jun. 6, 2014, which is herein incorporated by reference.

### BACKGROUND

1. Field of Invention

The present invention relates to a plate structure. More particularly, the present invention relates to a cabinet sidewall structure with hidden wall holes.

2. Description of Related Art

Conventional cabinets are usually composed of multiple wooden plates. Sidewalls of the conventional cabinet have two rows of wall holes on the front area and the rear area of each cabinet sidewall. When shelf support pegs are inserted into the wall holes on a right sidewall and a left sidewall of the cabinet at the same height, a supporting plate can be straddled on the shelf support pegs. The spacing between the supporting plates can be adjusted by inserting the shelf support pegs at a different height.

The wall holes of the conventional cabinet expose outside. Only the wall holes which are inserted by the shelf support pegs are covered by the shelf support pegs, and the other wall holes which are not selected to be inserted by the shelf support pegs still expose outside. Hence, the wall holes cause blemishes on the visual quality of the cabinet.

### SUMMARY

The present invention provides a cabinet sidewall structure with hidden wall holes so that the wall holes are concealed.

According to one aspect of the present invention, a cabinet sidewall structure with hidden wall holes is provided. The cabinet side all structure with hidden wall holes has a rectangular plate and at least one thin sheet material. The rectangular plate has a first planar surface, a second planar surface opposite to the first planar surface, a first side surface, a second side surface opposite to the first side surface, a first end surface, and a second end surface opposite to the first end surface. The first planar surface and/or the second planar surface have at least two wall hole rows in front area and in the rear area, and each of the wall hole rows has a plurality of wall holes arranged vertically. The thin sheet material is adhered to the first planar surface and/or the second planar surface to cover the wall holes.

According to one embodiment of the present invention, the thin sheet material is continuously adhered to the second planar surface, the first side surface, the first planar surface and the second side surface in sequence.

According to one embodiment of the present invention, the second planar surface further has a fillister adjacent to the second side surface. The fillister has a first inner wall and a second inner wall opposite to the first inner wall. The thin sheet material is continuously adhered to the first inner wall of the fillister, a part of the second planar surface between the fillister and the first side surface, the first side surface, the first planar surface, the second side surface, a part of the second planar surface between the second side surface and the fillister, and the second inner wall of the fillister in sequence.

According to one embodiment of the cabinet sidewall structure with hidden wall holes of the present invention, the wall holes of the rectangular plate is covered and hidden by the thin sheet material. The unused wall holes, i.e. the wall holes are not inserted by shelf support pegs, are concealed from view so that the appearance of the cabinet is complete and pleasing to the eye.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic perspective view of a cabinet sidewall structure with hidden wall holes according to a first embodiment of the present invention;

FIG. 2 depicts a schematic cross-sectional view taken along line A-A of the cabinet sidewall structure with hidden wall holes depicted in FIG. 1;

FIG. 3 depicts a schematic cross-sectional view taken along line A-A of the cabinet sidewall structure with hidden wall holes depicted in FIG. 1;

FIG. 4 depicts a schematic cross-sectional view of a cabinet sidewall structure with hidden wall holes according to a second embodiment of the present invention;

FIG. 5 depicts a schematic cross-sectional view of a cabinet sidewall structure with hidden wall holes according to a third embodiment of the present invention; and

FIG. 6 depicts a schematic cross-sectional view of a cabinet sidewall structure with hidden wall holes according to a fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

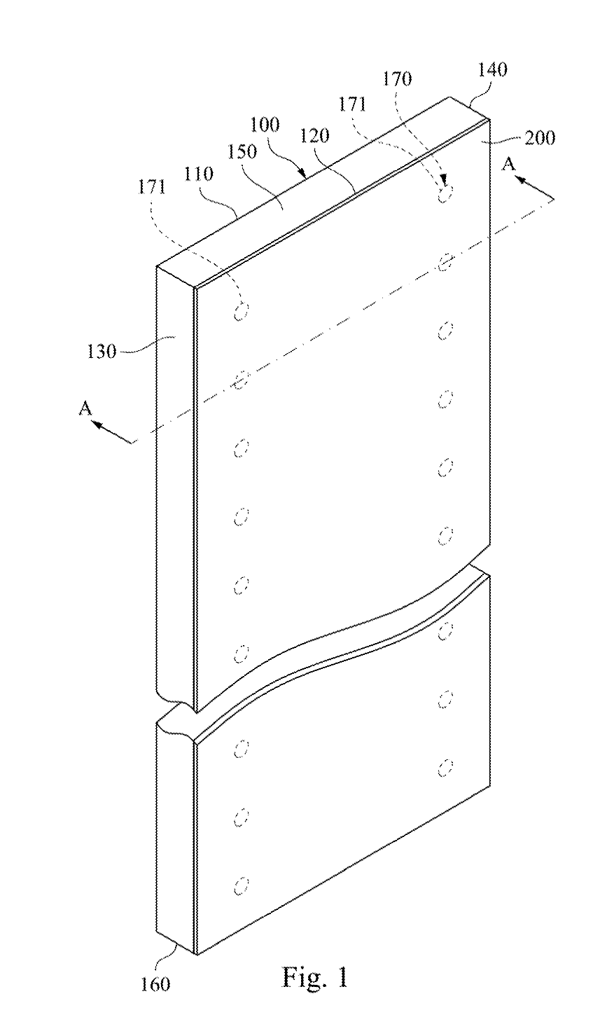

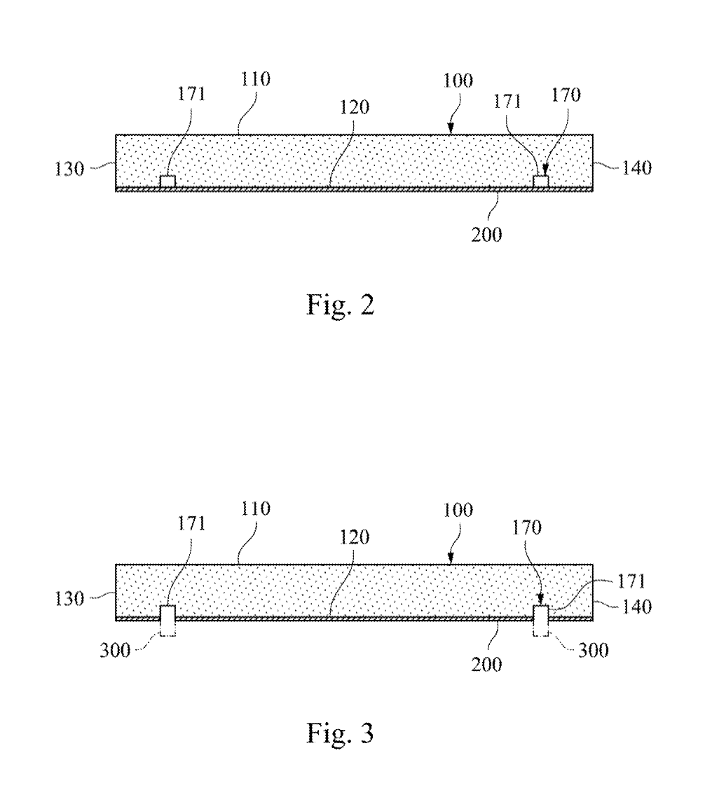

Refer to FIGS. 1 and 3. The cabinet sidewall structure with hidden wall holes according to a first embodiment of the present invention has a rectangular plate 100 and a thin sheet material 200.

The rectangular plate 100, e.g. a particleboard, a chipboard or a medium density fiber (MDF) board, is provided with a suitable thickness. The rectangular plate 100 has a first planar surface 110, a second planar surface 120 opposite to the first planar surface 110, a first side surface 130, a second side surface 140 opposite to the first side surface 130, a first end surface 150, and a second end surface 160 opposite to the first end surface 150. The second planar surface 120 has two wall hole rows 170 in the front area and the rear area. Each wall hole rows has a plurality of wall holes 171 arranged vertically.

The thin sheet material 200 is a thin and flexible material sheet, e.g. a decoration paper. The thin sheet material 200 is adhered on the second planar surface 120 of the rectangular plate 100 to decorate the appearance fo the rectangular plate 100 to cover the wall holes 171. The thin sheet material 200 can effective cover and hide the wail holes 171. The thin sheet material 200 has an extremely thin thickness and suitable pervious to light so as to recognize the positions of the wall holes 171.

Simultaneously refer to FIG. 3. While assembling the cabinet, the user can align the shelf support pegs 300 to the wall holes 171 at a desired height, and penetrate the thin sheet material 200 corresponding to the wall holes 171 at the desired height. In addition, the shelf support pegs 300 are fixed in the wall holes 171 at the desired height to support a supporting plate (not shown) on the shelf support pegs 300. The other unselected wall holes are still covered by the thin sheet material 200 so as to hide on the thin sheet material 200. Therefore, the other wall holes are concealed from view and the appearance of the cabinet is complete and pleasing to the eye.

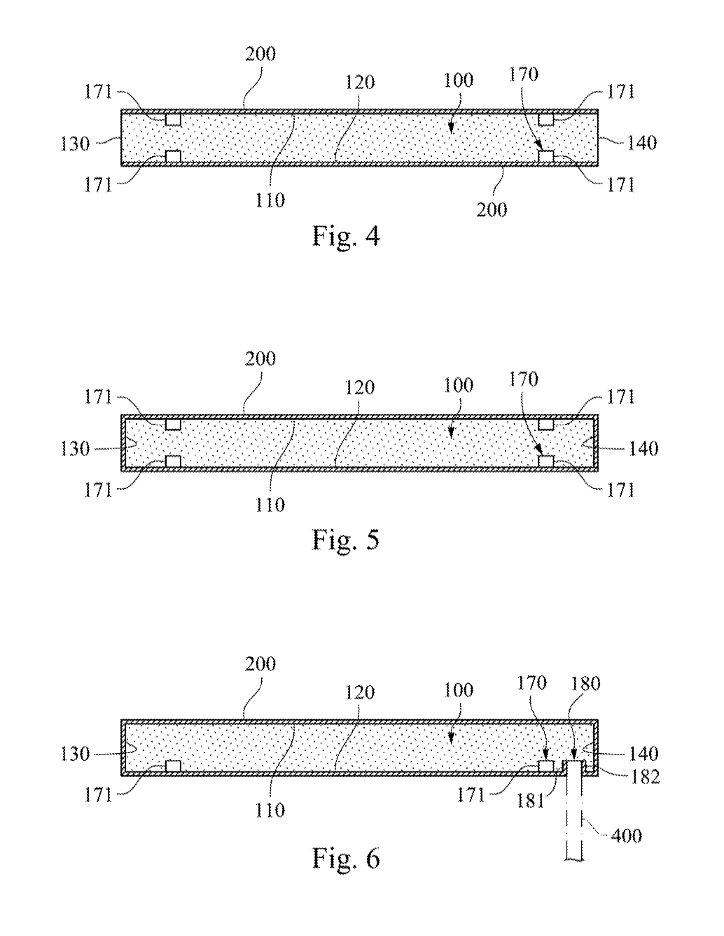

Refer to FIG. 4, FIG. 4 depicts a schematic cross-sectional view of a cabinet sidewall structure with hidden wall holes according to a second embodiment of the present invention. In the embodiment, each of the first planar surface 110 and the second planar surface 120 of the rectangular plate 100 has two wall hole rows 170 in the rear area and front area. Each wall hole row has a plurality of wall holes 171 arranged vertically. The thin sheet material 200 is adhered on the first planar surface 110 and the second planar surface 120 to cover and hide the wall holes 171 of the rectangular plate 100. The second embodiment of the cabinet sidewall structure can suitable to be used in a middle plate to support the supporting plate on the right side and the left side of the middle plate. The cabinet sidewall structure of the second embodiment according to the present invention can also provide the same function as described in the cabinet sidewall structure of the first embodiment according to the present invention.

Refer to FIG. 5. FIG. 5 depicts a schematic cross-sectional view of a cabinet sidewall structure with hidden wall holes according to a third embodiment of the present invention. In the embodiment, each of the first planar surface 110 and the second planar surface 120 of the rectangular plate 100 has two wall hole rows 170 in the front area and the rear area. Each wall hole row 170 has a plurality of wall holes 171 arranged vertically. The thin sheet material 200 is continuously adhered to the second planar surface 120, the first side surface 130, the first planar surface 110 and the second side surface 140 in sequence to decorate the surfaces of the rectangular plate 100, and cover and hide the wall holes 171 of the rectangular plate 100. In addition, the cabinet sidewall structure of the third embodiment according to the present invention can also provide the same function as described in the cabinet sidewall structure of the first embodiment according to the present invention.

Refer to FIG. 6. FIG. 6 depicts a schematic cross-sectional view of a cabinet sidewall structure with hidden wall holes according to a fourth embodiment of the present invention. In the embodiment, the second planar surface 120 of the rectangular plate 100 has two wall hole rows 170 in the front area and the rear area. Each wall hole row has a plurality of wall holes 171 arranged vertically. In addition, a fillister 180 is formed on the second planar surface 120 adjacent to the second side surface 140. The fillister 180 has a first inner wall 181 and a second inner wall 182 opposite to each other. The thin sheet material 200 is continuously adhered to the first inner wall 181 of the fillister 180, the first inner wall 181, a part of the second planar surface 120 between the fillister 180 and the first side surface 130, the first side surface 130, the first planar surface 110, the second side surface 140, a part of the second planar surface 120 between the second side surface 140 and the fillister 180, the second inner wall 182 of the fillister 180. The fillister 180 can engage with a back plate 400 of the cabinet. The cabinet sidewall structure of the fourth embodiment according to the present invention can also provide the same function as described in the cabinet sidewall structure of the first embodiment according to the present invention.

According to one embodiment of the cabinet sidewall structure with hidden wall holes of the present invention, the wall holes 171 of the rectangular plate 100 is covered and hidden by the thin sheet material 200. The unused wall holes, i.e. the wall holes are not inserted by shelf support pegs, are concealed from view so that the appearance of the cabinet is complete and pleasing to the eye.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cabinet sidewall structure with hidden wall holes, comprising:
a rectangular plate having a first planar surface, a second planar surface opposite to the first planar surface, a first side surface, a second side surface opposite to the first side surface, a first end surface, and a second end surface opposite to the first end surface, the first planar surface and the second planar surface having at least two wall hole rows in front area and in the rear area, each of the wall hole rows having a plurality of wall holes arranged vertically; and
at least one thin sheet material adhered to the first planar surface and the second planar surface to cover the wall holes.

2. The cabinet sidewall structure with hidden wall holes of claim 1, wherein the thin sheet material is continuously adhered to the second planar surface, the first side surface, the first planar surface and the second side surface in sequence.

3. The cabinet sidewall structure with hidden wall holes of claim 1, wherein the second planar surface further comprises a fillister adjacent to the second side surface, the fillister comprising a first inner wall and a second inner wall opposite to the first inner wall, wherein the thin sheet material is continuously adhered to the first inner wall of the fillister, a part of the second planar surface between the fillister and the first side surface, the first side surface, the first planar surface, the second side surface, a part of the second planar surface between the second side surface and the fillister, and the second inner wall of the fillister in sequence.

4. A cabinet side all structure with hidden wall holes, comprising:
a rectangular plate having a first planar surface, a second planar surface opposite to the first planar surface, a first side surface, a second side surface opposite to the first side surface, a first end surface, and a second end surface opposite to the first end surface, one of the first planar surface and the second planar surface having at least two wall hole rows in front area and in the rear area, each of the wall hole rows having a plurality of wall holes arranged vertically; and
at least one thin sheet material adhered to the one of the first planar surface and the second planar surface to cover the wall holes.

5. The cabinet sidewall structure with hidden wall holes of claim 4, wherein the thin sheet material is continuously adhered to the second planar surface, the first side surface, the first planar surface and the second side surface in sequence.

6. The cabinet sidewall structure with hidden wall holes of claim 4, wherein the second planar surface further comprises a fillister adjacent to the second side surface, the fillister comprising a first inner wall and a second inner all opposite to the first inner wall, wherein the thin sheet material is continuously adhered to the first inner all of the fillister, a part of the second planar surface between the fillister and the first side surface, the first side surface, the first planar surface, the second side surface, a part of the second planar surface between the second side surface and the fillister, and the second inner wail of the fillister in sequence.
